(19) United States
(12) Patent Application Publication
(10) Pub. No.: US 2014/0249962 A1
(43) Pub. Date: Sep. 4, 2014

(54) INTERACTIVE PLATFORM SYSTEM FOR A HANDHELD WIRELESS DEVICE BASED ON ITS LOCATION AND METHOD THEREOF

(71) Applicant: Ping-Lun HSIEN, Tiapei (TW)

(72) Inventor: Ping-Lun HSIEN, Tiapei (TW)

(21) Appl. No.: 13/783,314

(22) Filed: Mar. 3, 2013

(51) Int. Cl. G06Q 30/06

(52) U.S. Cl. CPC G06Q 30/0625
USPC 705/26.62

(57) ABSTRACT

An interactive platform system for a handheld wireless device based on its location and method thereof is provided. The server platform receives a query from the user end and issues a request to the mapping engine. The mapping engine searches the database and issues a list of the vendor ends based on the request and located within an area of a location of the user end. When one of the vendor ends within the list is selected by the user end, an instant messenger is established for communication directly between the user end and the selected vendor end. Also, the vendor end may requests an activity query to the server platform. Therefore, the application program may apply multiple diversification operations and interactive services.

### BACKGROUND OF THE INVENTION

1. Field of Invention

The present invention relates to a computer-network-based interactive platform system, in particular to a mapping system with instant communication thereof.

2. Related Art

Many online databases are concerned with data items that are inherently location based. For example, an online database of hotels or a database of real estate listings or a database of weekend garage sales can all have locations in the form of street addresses associated with them. In all these cases, the location information is an important aspect of each item, however, in many systems there is no easy way for the user to interact with the location aspect of the data.

For example, it is known to provide a web-based system that shows maps with numbered icons in response to a user's query. For example, if the user requests information on hotels in a big city, the system will show the user what hotels are available by displaying numbers at the locations on the map corresponding to the hotels. The user has to look up the number of the hotel on a legend, to find out what hotel corresponds to the number, and the user must then follow a link to another web page to obtain information about that hotel.

An improved system for presenting location information in response to a user's query is desired.

### SUMMARY OF THE INVENTION

The present invention overcomes the above-described and other problems and disadvantages in the prior art by providing a method and computer program adapted to generate an interactive map-based presentation that bases on a location of the user end which using a handheld wireless device and combines with an instant messenger for communication directly between the user end and the selected vendor end.

The present invention provides the system and the method to map the user ends and the vendor ends by a server platform. The server platform includes a mapping engine and a database. The server platform receives a query from the user end and issues a request to the mapping engine. The mapping engine searches the database and issues a list of the vendor ends based on the request and located within an area of a location of the user end. When one of the vendor ends within the list is selected by the user end, an instant messenger is established for communication directly between the user end and the selected vendor end.

On the other hand, the server platform may receive an activity query from the vendor end and issues a request to the mapping engine. The mapping engine searches the database and issues a list of the user ends based on the request and located within an area of a location of the user end. The activity query is sent to the user ends within the list. Furthermore, when one of the user end confirms the activity query, an instant messenger is established for communication directly between the vendor end and the confirm user end.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and where in:

FIG. 1 illustrates the example of the interactive platform system according to the present invention.

FIGS. 2A-2C illustrate the examples of the area of the location for the interactive platform system according to the present invention.

FIG. 3 illustrates the example of the block diagram of the interactive platform system according to the present invention.

FIGS. 4A-4B illustrate the flow chart diagrams of the interactive platform method according to the present invention.

FIGS. 5A-5B illustrate the flow chart diagrams of another embodiment of the interactive platform method according to the present invention.

FIGS. 6A-6C illustrate the examples of the area of the location for the interactive platform method of FIGS. 5A-5B according to the present invention.

### DETAILED DESCRIPTION OF THE INVENTION

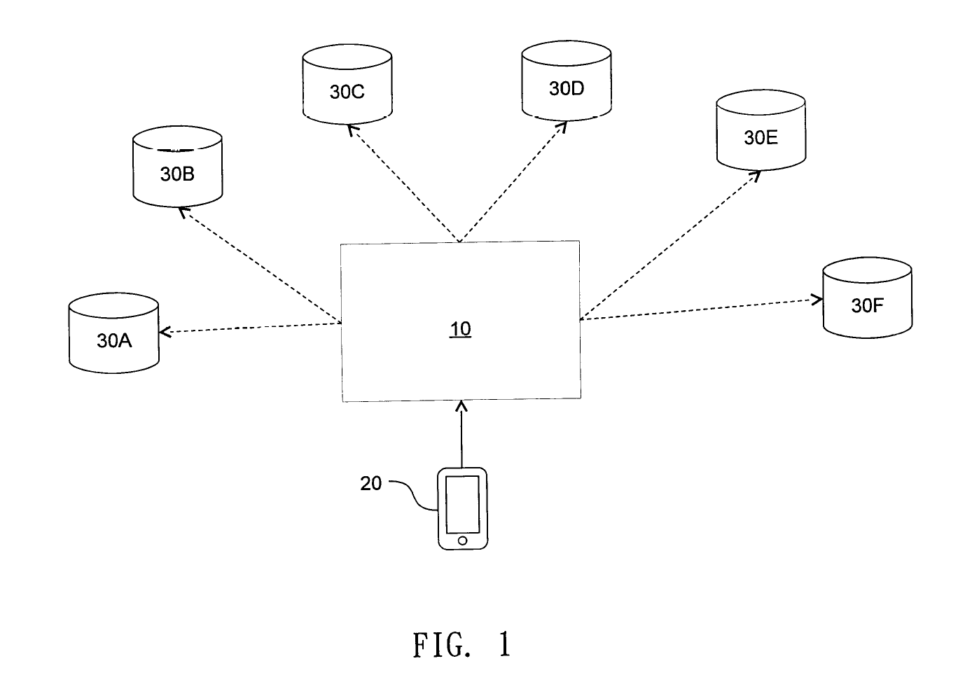

Please see FIG. 1, it illustrates the example of the interactive platform system according to the present invention.

The user end 20 is connected to the server platform 10 by a handheld wireless device, such as a smart phone, a tablet computer, a personal digital assistant, etc. Several vendor ends 30A-30F is connected, wired or wireless, to the server platform 10. The user end 20 sends a query, such as book or reserve, to the server platform 10 by the wireless device. The server platform 10 receives the query from the user end 20 and issues a request to search. Then, a list of the vendor ends 30A-30F is issued based on the request and located within an area of a location of the user end 20. When one of the vendor ends 30A-30F within the list is selected by the user end 20, an instant messenger is established for communication directly between the user end 20 and the selected vendor end 30A-30F.

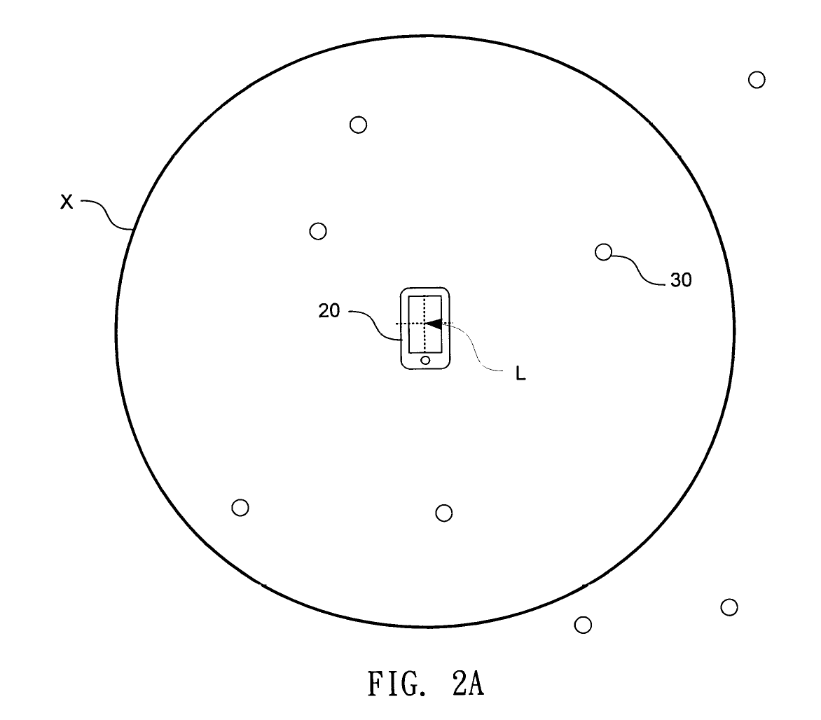

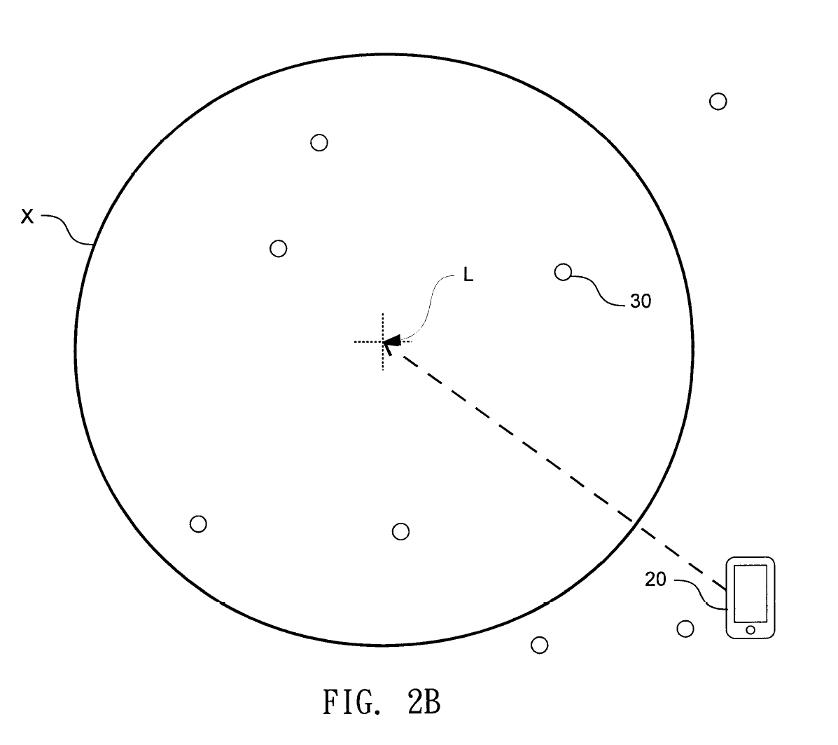

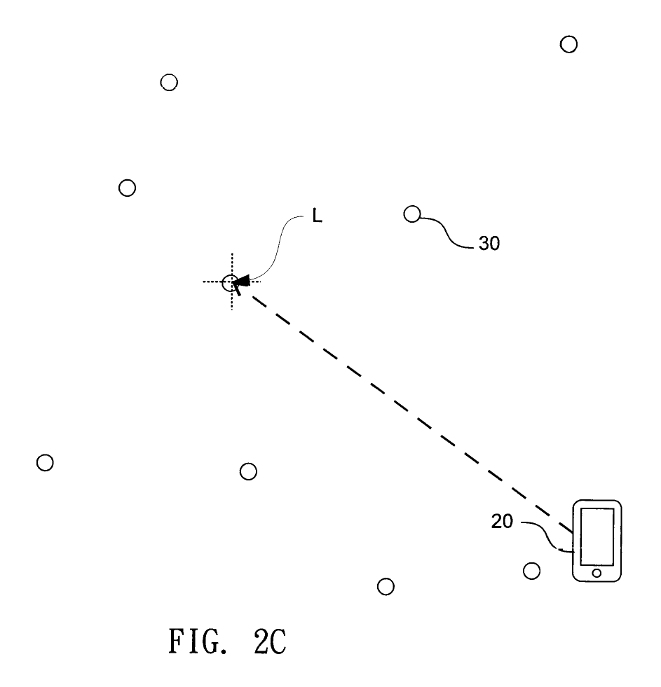

Please see FIGS. 2A-2C, showing the examples of the area of the location for the interactive platform system according to the present invention.

A software, such as an application program, is installed in the wireless device of the user end 20. When the query is received, the area X is determined by the server platform 10. The area X may be a default range of the location L, or set up by the user end 20. As refer to FIG. 2A, the location L of the user end 20 may be defined by a Global Positioning System, a WIFI, such as access point, or a cellular basestation. The server platform 10 searches the vendor ends 30A-30F within the area X and satisfied with the request and issues the list accordingly. On the other hand, the user end 20 may offer an address as the location L to search, please see FIG. 2B. Furthermore, the appointed address may be a specific vendor end 30, please see FIG. 2C.

When the list is available, the user end 20 may select one of the vendor end 30. The instant messenger is established for communication directly between the user end 20 and the selected vendor end 30. The user end 20 can communicate with the vendor end 30 to book, reserve, or order for testing drive a car, booking a mom, making a reservation, or per-ordering a meal, and so on.

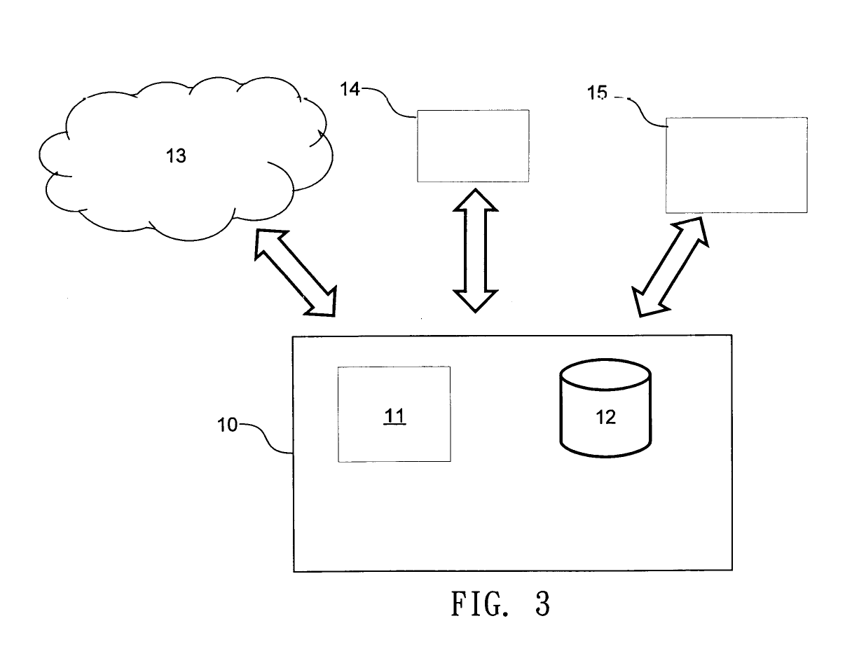

Please see FIG. 3, it illustrates the example block diagram of the interactive platform system according to the present invention.

The server platform 10 includes a mapping engine 11 and the database 12. The server platform 10 receives the query from the user end 20 and issues the request to the mapping engine 11. The mapping engine 11 searches the database 12 and issues the list of the vendor ends 30 based on the request and located within the area X of the location L of the user end 20. An information of the vendor ends 20 are stored in the database 12, and the information includes news, website, rating and comments, etc. The information of the vendor ends 30 may be shown to the user end 20 when the vendor ends 30 are within the list. The user end 20 may select the vendor end 30 by referring to the information. A selected number of the vendor end 30 is counted and stored in the database 12. The amount of the select number may also be offered to the user end 20, or to the vendor end 30 for reference. The user end 20 may provide his comments for the vendor end 30 to be stored in the database 12.

On the other hand, the server platform 10 is further connected to a positioning mechanism 15, a map resource 14 and a cross-platform engine 13. The positioning mechanism 15 obtains the location L of the user end 20. The map resource 14 displays a map to the user end 20 according to the location L. The issued list of the vendor ends 30 may be shown on the map. The cross-platform engine 13 acquires an information of the vendor ends 30 to the user end 20 from other platforms. Therefore, the user end may realize the information of the vendor end 30 which is interested from the other platforms.

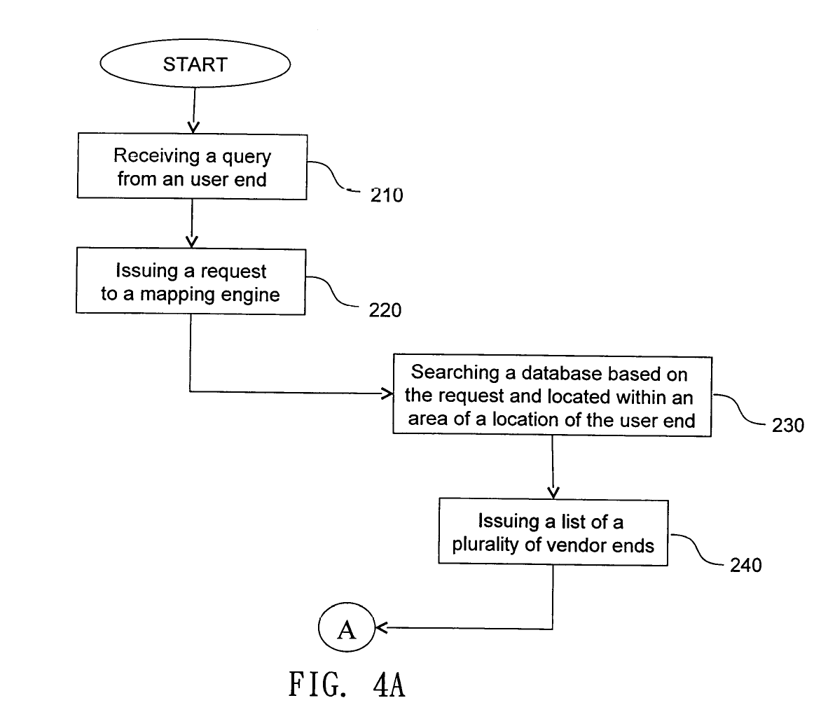

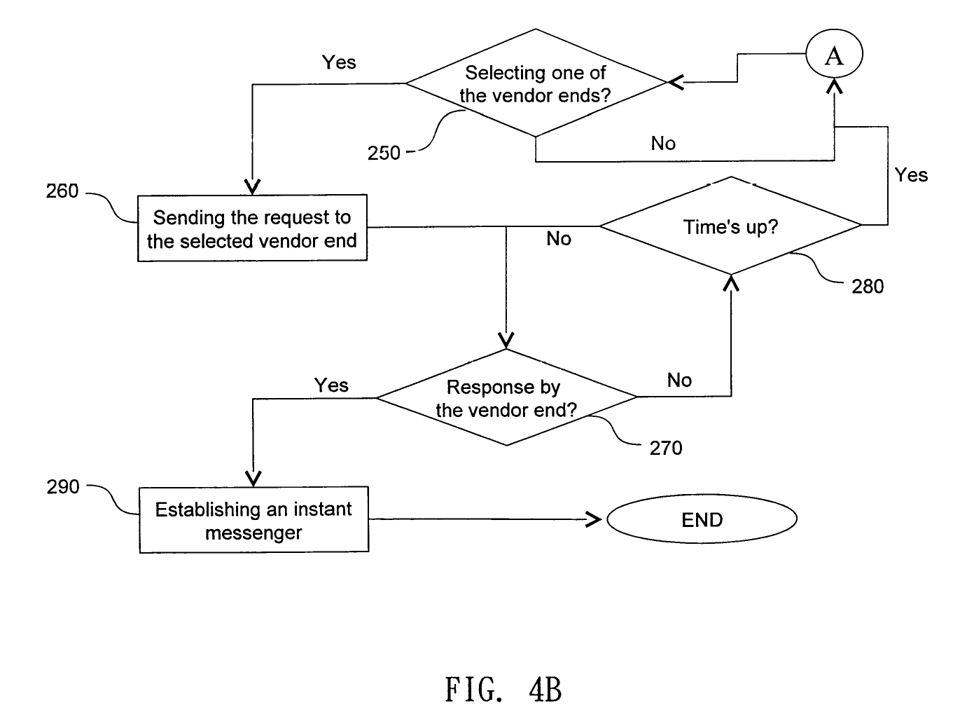

FIGS. 4A-4B illustrate the flow chart diagrams of the interactive platform method according to the present invention.

The server platform 10 receives a query from an user end 20, step 210, and issues a request to a mapping engine 11 according to the query, step 220.

Then, the mapping engine 11 searches a database 12 based on the request and located within an area X of a location L of the user end 20, step 230, and issues a list of a plurality of vendor ends 30, step 240. At step 250, a determination is made whether one of the vendor ends 30 within the list is selected. If yes, the server platform 10 sends the request to the selected vendor end 30, step 260. If not, the server platform 10 may delete the list after an idle time to reduce the load of the server platform 10.

At step 270, a determination is made whether the selected vendor end 30 responses. If the selected vendor end 30 responses the request, an instant messenger is established for communication directly between the user end 20 and the selected vendor end 30, step 290. If the selected vendor end 30 does not response the request and after a waiting time, step 280, the user end 20 is requested to select another vendor end 30.

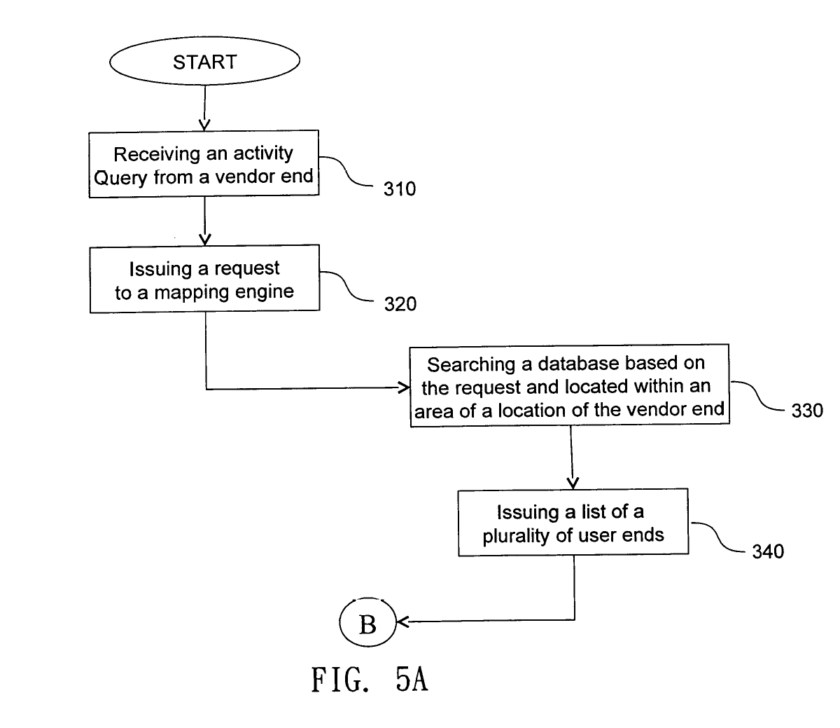

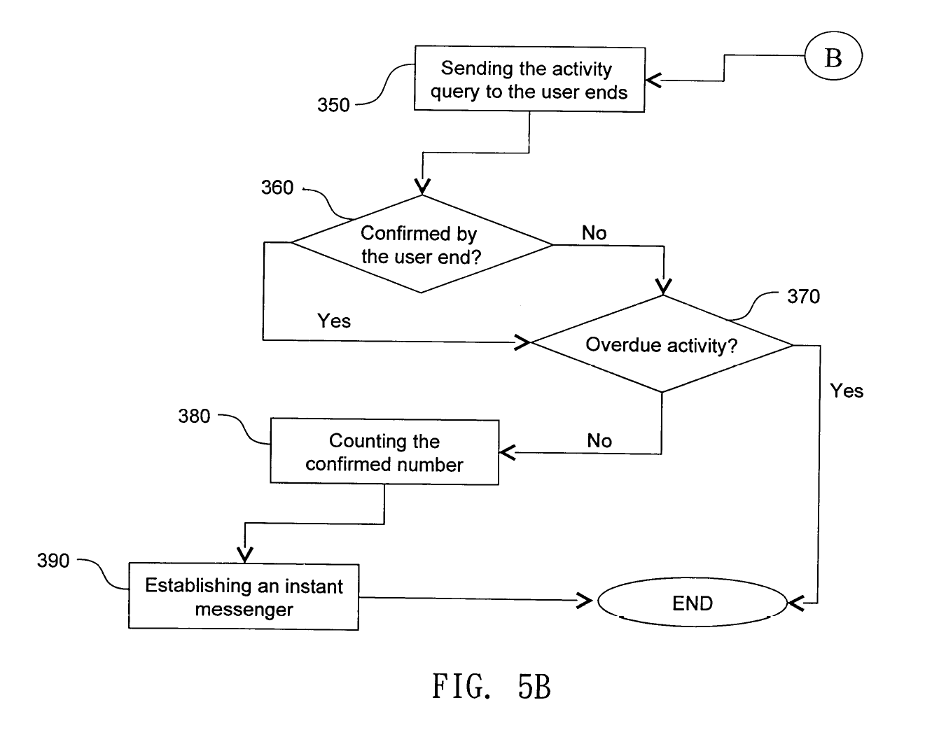

FIGS. 5A-5B illustrate the flow chart diagrams of another embodiment of the interactive platform method according to the present invention. The vendor end 30 may also utilize this system to advertise an activity.

The server platform 10 receives an activity query from a vendor end 30, step 310, and issues a request to a mapping engine 11 according to the query, step 320.

Then, the mapping engine 11 searches a database 12 based on the request and located within an area X of a location L of the vendor end 30, step 330, and issues a list of a plurality of user ends 20, step 340. Then the activity query is sent to the user ends 20 within the list, step 350.

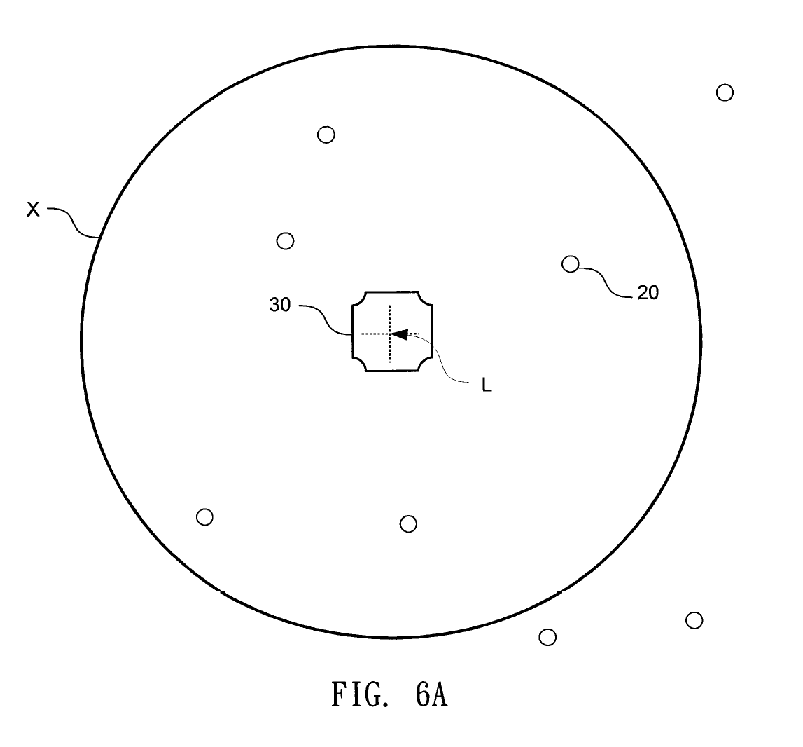

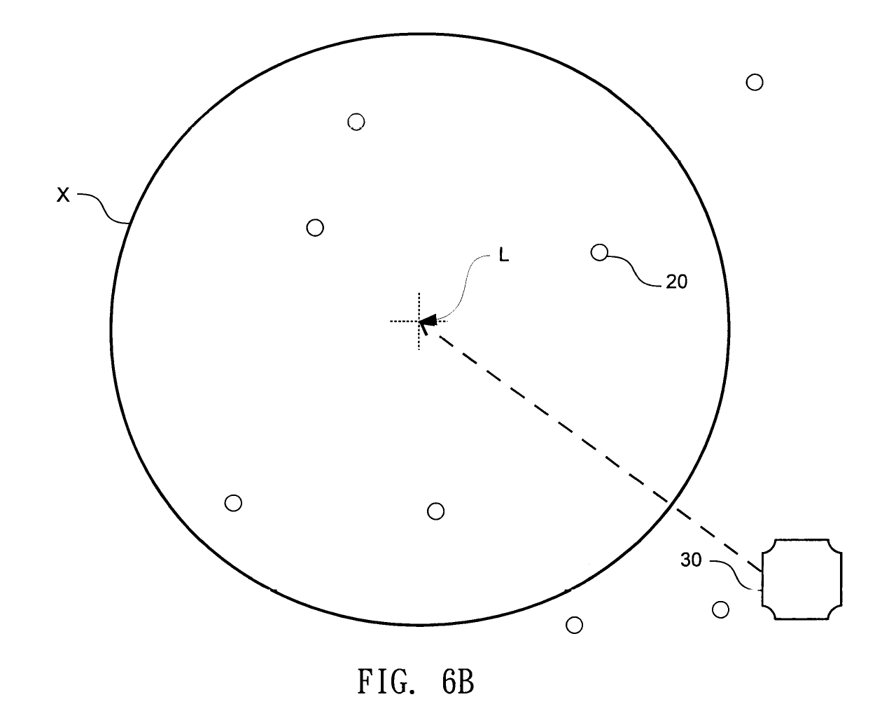

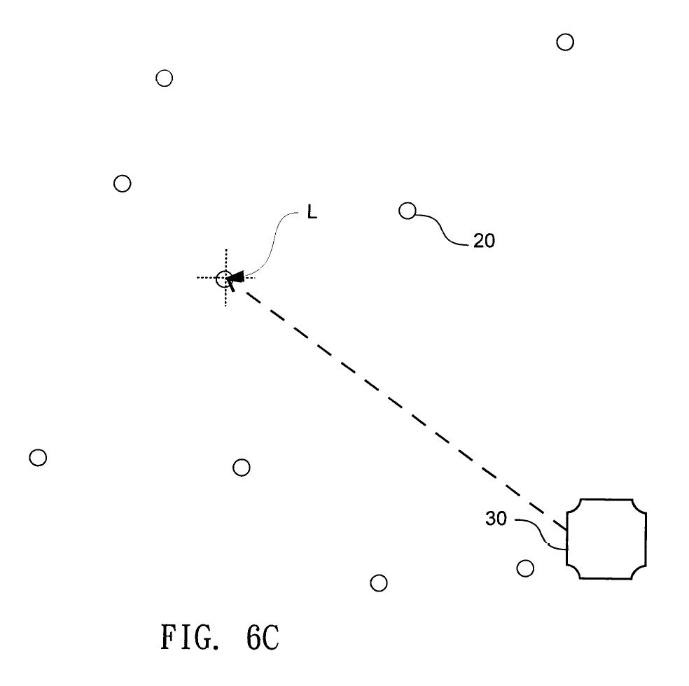

The area X may be a default range of the location L of the vendor end 30, or set up by the vendor end 30. As refer to FIG. 6A, the location L of the vendor end 30 may be defined by a Global Positioning System, a WIFI, such as access point, or a cellular base station. The server platform 10 searches the user ends 20 within the area X and satisfied with the request, which may include gender, age, career, etc. On the other hand, the vendor end 30 may offer an address as the location L to search, please see FIG. 6B. Furthermore, the appointed address may be specific user ends 20, please see FIG. 6C.

At step 360, a determination is made whether one of the user ends 20 within the list is confirmed. At step 370, a determination is made whether the activity is overdue. If the activity does not overdue, a confirmed number of the user end is counted and stored, step 380. And an instant messenger may be established for communication directly between the confirm user end 20 and the vendor end 30, step 390.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system, comprising:
an user end, sending a query by a wireless device;
a server platform, including a mapping engine and a database, receiving the query from the user end and issuing a request to the mapping engine; and
a plurality of vendor ends, connected to the server platform;
wherein the mapping engine searches the database and issues a list of the vendor ends based on the request and located within an area of a location of the user end, when one of the vendor ends within the list is selected by the user end, an instant messenger is established for communication directly between the user end and the selected vendor end.

2. The system of claim 1, wherein an information of the vendor ends are stored in the database, and the information includes news, website, rating and comments.

3. The system of claim 2, wherein the information of the vendor ends are shown to the user end.

4. The system of claim 1, wherein a selected number of the vendor end is counted and stored in the database.

5. The system of claim 1, wherein the server platform is connected to:
a positioning mechanism, obtaining the location of the user end;
a map resource, displaying a map to the user end according to the location; and
a cross-platform engine, acquiring an information of the vendor ends to the user end from other platforms.

6. The system of claim 5, wherein the location of the user end is defined by a Global Positioning System, a WIFI, a cellular basestation or an address, and a range of the area is determined by the end user.

7. A method comprising:
receiving a query from an user end;
issuing a request to a mapping engine according to the query;
searching a database based on the request and located within an area of a location of the user end and issuing a list of a plurality of vendor ends;
selecting one of the vendor ends within the list;
sending the request to the selected vendor end;and
establishing an instant messenger for communication directly between the user end and the selected vendor end.

8. The method of claim 7, wherein the location of the user end is defined by a Global Positioning System, a WIFI, a cellular basestation or an address, and a range of the area is determined by the end user.

9. The method of claim 7, wherein an information of the vendor ends is shown to the user end, and the information includes news, website, rating and comments.

10. The method of claim 7, wherein a selected number of the vendor end is counted and stored, the vendor ends within the list are sorted by the number.

11. The method of claim 7, wherein when the selected does not response the request, the user end is requested to select another vendor end.

12. A method comprising:
receiving an activity query from a vendor end;
issuing a request to a mapping engine according to the activity query;
searching a database based on the request and located within an area of a location of the vendor end and issuing a list of a plurality of user ends; and
sending the activity query to the user ends within the list.

13. The method of claim 12, wherein the location of the vendor end is defined by a Global Positioning System, a WIFI, a cellular basestation or an address, and a range of the area is determined by the vendor user.

14. The method of claim 12, wherein a confirmed number of the user end is counted and stored.

15. The method of claim 12, wherein when one of the user end confirms the activity query, an instant messenger is established for communication directly between the vendor end and the confirm user end.
